(19) United States
(12) Patent Application Publication
(10) Pub. No.: US 2017/0215586 A1
(43) Pub. Date: Aug. 3, 2017

(54) CONNECTION MEMBER FOR CONNECTING A WALL-ATTACHABLE BODY TO A WALL-MOUNTED BRACKET

(71) Applicant: Fetim B.V., Amsterdam (NL)

(72) Inventor: Thomas Gerardus Petrus Zonneveld, Amsterdam (NL)

(73) Assignee: Fetim B.V., Amsterdam (NL)

(21) Appl. No.: 15/309,447

(22) PCT Filed: May 8, 2015
(86) PCT No.: PCT/NL2015/050315

§ 371 Date: Nov. 8, 2016

(30) Foreign Application Priority Data
May 8, 2014 (NL) 2012783

(51) Int. Cl. A47B 96/06; F16B 12/10

(52) U.S. Cl. CPC A47B 96/066; F16B 12/10; F16B 2012/103

(57) ABSTRACT

The invention relates to a connection member (1) for connecting a wall-attachable body (2), having an elongated hole (3) for receiving the connection member, to a wall-mountable bracket (4) provided with an elongated projection member (5) during use projecting away from a mounting wall (6) along a projection member axis (P), the projection member therein being insertable into an insertion space (S) of the connection member through an insertion opening (7), the connection member comprising an elongated, tubular body (8) having a tubular wall (9) comprising the insertion space, having an intermediate zone provided with slits (13) extending parallel to the connection member axis, the slits dividing the tubular wall in the intermediate zone into multiple, elongated wall segments, the elongated wall segments (14) being made of a resilient material.

### FIELD OF THE INVENTION

The present invention relates to a connection member for connecting a wall-attachable body to a wall-mounted bracket as well as a wall-mounted assembly comprising such a connection member.

### BACKGROUND OF THE INVENTION

It is known to provide a wall-attachable body, such as a floating shelf, with one or more elongated holes and to subsequently slide the wall-attachable body over one or more elongated projection members of a wall-mounted bracket in order to mount the wall-attachable body to the wall.

For instance, EP 0488697 describes a shelving assembly which includes a shelf and a mounting member, a portion of which is received by and extends within an opening in the edge of the shelf. A friction bush is provided to resist relative movement between the shelf and the mounting member and comprises a sleeve having an internal surface and an external surface and is sized so as to be received upon that portion of the mounting member which is in turn received within the edge of the shelf. The sleeve is provided with a first means on the internal surface to mate with cooperating means provided on that portion of the mounting member that receives the sleeve and second means on the external surface to engage within the opening in edge of the shelf

A disadvantage of the known assemblies, however, is that rattling and unwanted movement may occur due to the one or more elongated projection members not providing a perfect fit with the elongated holes. In some situations, the wall-attachable body can easily be slid off the projection members without much effort. This is highly undesirable, especially when the wall-attachable body is relatively heavy or when the wall-attachable body is a shelf or the like used to support heavy objects, such as books.

Attempts have been made to create another hole in the wall-attachable body perpendicular to the elongated hole for receiving a screw, pen or the like therein. The screw is used to engage the elongated projection member in order to at least prevent movement of the wall-attachable body in a longitudinal direction of the one or more projection members, i.e. to prevent the wall-attachable body from sliding off the projection members.

The problem of rattling, i.e. movement of the wall-attachable body in a direction perpendicular to the projection members, however, still exists.

It is therefore an object of the present invention to provide a connection member capable of preventing the wall-attachable body from sliding off the projection members of the wall-mounted bracket and at the same time being capable of preventing or at least minimizing the problem of rattling.

EP 2177129 describes general state of the art, disclosing a fastening device to fasten a shelf to the frame of a piece of furniture, comprising an anchoring body conformed to be inserted into a corresponding seat formed in the edge of the shelf and a pin member housable in an internal cavity of the anchoring body and slideable in it along an axis between two positions.

DE 202008015732 and DE 102009031101 also both describe general state of the art, disclosing a connection system for connecting a lightweight shelf to another lightweight shelf or a wall plate.

### SUMMARY OF THE INVENTION

Hereto, according to the invention, a connection member is provided for connecting a

wall-attachable body, having an elongated hole for receiving the connection member, to a

wall-mountable bracket provided with an elongated projection member during use projecting away from a mounting wall along a projection member axis, the projection member therein being insertable into an insertion space of the connection member through an insertion opening,

the connection member comprising:

an elongated, tubular body having a tubular wall comprising the insertion space, the tubular wall and the insertion space extending along a connection member axis alignable with the projection member axis when the projection member is inserted into the connection member,

wherein the tubular body, when viewed along the connection member axis in a direction away from the mounting wall, comprises a proximal end zone, provided with the insertion opening, an intermediate zone and a distal end zone,

wherein an inner diameter of the tubular wall in the proximal end zone and the distal end zone is equal to or larger than an outer diameter of the projection member,

wherein the intermediate zone is provided with slits extending parallel to the connection member axis, the slits dividing the tubular wall in the intermediate zone into multiple, elongated wall segments, the elongated wall segments being made of a resilient material,

wherein a radial wall thickness of the elongated segments is so chosen that,

when the projection member is not inserted into the connection member, an inner diameter of the tubular wall in the intermediate zone is smaller than the outer diameter of the projection member, whereas,

when the projection member is inserted into the insertion space, the elongated segments are pushed outwardly in radial direction by the projection member, wherein an outer diameter of the segments is equal to an outer diameter of the tubular wall in the proximal end zone and the distal end zone, wherein the tubular wall has a constant-diameter outer contact surface when viewed along the connection member axis, wherein the outer surface of the connection member engages the wall-attachable body in a clamping manner.

The above-described connection member substantially reduces the problem of unwanted movement of the wall-attachable body with respect to the elongated projection members, both in longitudinal as well as radial direction. The resilient, elongated segments of the intermediate zone provide a firm connection between both the projection member and the connection member and between the connection member and the wall-attachable body.

At the same time, however, the resilient, elongated segments advantageously allow the removal of the connection member out of the elongated hole of the wall-attachable body, if desired.

An embodiment relates to an aforementioned connection member, wherein the length of the intermediate zone is 1-10 cm, preferably 2-6 cm, more preferably 3-5 cm. The inventors have found that this length range provides optimal grip between both the projection member and the connection member and between the connection member and the wall-attachable body. I.e. not too much grip as to make removal of the connection member overly difficult, and not too little grip as to allow unwanted movement of the connection member.

An embodiment relates to an aforementioned connection member, wherein the length of the tubular body is 1-15 cm, preferably 3-10 cm, more preferably 5-9 cm, most preferably 8 cm. This length range of the tubular body allows it to be used with a wide range of wall-attachable bodies, while still preventing unwanted movement.

An embodiment relates to an aforementioned connection member, wherein the elongated, tubular body has a cylindrical shape. The cylindrical shape allows for easy insertion and even distribution of in particular radial forces.

An embodiment relates to an aforementioned connection member, wherein the amount of slits is 3-8, preferably 4-6, most preferably 6, wherein the slits are evenly distributed in circumferential direction. Such an amount of slits provides a relatively optimal balance between resiliency of the elongated segments in the intermediate zone and constructional strength of the intermediate zone itself.

An embodiment relates to an aforementioned connection member, wherein the proximal end zone is provided with a flange extending perpendicularly to the connection member axis. Such a flange prevents the connection member from being inserted too far into the elongated hole in the wall-attachable body. At the same time the flange facilitates removal of the connection member from the hole, if desired.

An embodiment relates to an aforementioned connection member, wherein the flange projects with respect to the proximal end zone over a distance of 1-5 mm, such as 2-4 mm, for instance 3 mm. In practice, the inventors have found that such a flange width provides a good balance between allowing the connection member to be grabbed easily for removal on the one hand and ease of handling, storability and aesthetics on the other hand.

An embodiment relates to an aforementioned connection member, wherein the proximal and distal end zones of the tubular body have an outer diameter of 1-3 cm, preferably 1.4-2.6 cm, most preferably 2.2 cm. Especially for wall-attachable bodies having a relatively small height, such as shelves, in particular floating shelves, having a commonly used height of for instance 5-10 cm, such a diameter is found to be beneficial: the structural integrity of the shelf is hardly compromised, while at the same time still sufficient outer contact surface for the tubular body is realized.

An embodiment relates to an aforementioned connection member, wherein an outer circumference of the proximal end zone is provided with a plurality of ribs extending parallel to the connection member axis, the ribs being evenly distributed in circumferential direction. These ribs allow a firmer grip of the outer circumference of the proximal end zone of the plug with the hole in the wall-attachable body. This is especially useful if the connection member has been removed from, and reinserted in, the same hole multiple times.

An embodiment relates to an aforementioned connection member, wherein wherein the width of the slits is approximately 1-3 mm, such as 2 mm. This slit width also provides a relatively optimal balance between resiliency of the elongated segments in the intermediate zone and constructional strength of the intermediate zone itself.

Another aspect of the invention relates to a subassembly of a wall-attachable body and a connection member according to any one of the preceding claims, the connection member being received into the elongated hole of the wall-attachable body. This subassembly can easily be slid, as a whole, over the one or more elongated projection members.

An embodiment relates to an aforementioned subassembly, wherein the wall-attachable body is a floating shelf having a main support surface for supporting objects and one or more side surfaces, wherein the elongated hole is provided in one of the side surfaces, the connection member being received in the elongated hole.

An embodiment relates to an aforementioned subassembly, wherein the side surface is provided with a plurality of elongated holes, such as 2, evenly spaced-apart over the side surface, for receiving a plurality of connection members therein. This allows forces exerted on the wall-attachable body to be distributed evenly over the connection members and ultimately over the elongated projection members of the wall-mounted bracket.

Another aspect of the invention relates to a wall-mounted assembly of a wall-mounted bracket provided with an elongated projection member projecting away from a mounting wall along a projection member axis, and an aforementioned subassembly, the projection member being inserted into the insertion space of the connection member.

An embodiment relates to an aforementioned wall-mounted assembly, wherein the wall-attachable body is provided with a plurality of elongated holes, such as 2, receiving a plurality of connection members therein, and a plurality of elongated projection members being inserted into the plurality of connection members. As stated before, this guarantees optimal distribution of forces over the connection members, and the projection members.

Another aspect of the invention relates to a method for mounting a wall-attachable body to a wall-mounted bracket on a mounting wall, the wall-attachable body comprising an elongated hole for receiving an aforementioned connection member, the wall-mounted bracket being provided with an elongated projection member projecting away from the mounting wall along a projection member axis, the projection member therein being insertable into the insertion space of the connection member through the insertion opening, comprising the steps of:
inserting the distal end zone of the connection member into the elongated hole of the wall-attachable body until the proximal end zone is fully inserted into the elongated hole, to obtain an aforementioned subassembly,
inserting the elongated projection member into the insertion space of the connection member of the subassembly through the insertion opening,
moving the subassembly in the direction of the wall over the projection member until a firm fit is provided between the projection member and the wall-mounted bracket on the one hand and the subassembly on the other hand, to obtain the aforementioned wall-mounted assembly, wherein the outer surface of the connection member engages the wall-attachable body in a clamping manner.

### BRIEF DESCRIPTION OF THE DRAWINGS

Embodiments of a connection member, an aforementioned subassembly and a wall-mounted assembly according to the invention will by way of non-limiting example be described in detail with reference to the accompanying drawings. In the drawings:

FIG. 1 shows an overview of a subassembly of a wall-attachable body and embodiments of connection members according to the invention being arranged therein for attachment to a wall-mountable bracket,

FIG. 2 shows a detailed view of the insertion opening of the subassembly of FIG. 1,

FIG. 3 shows a perspective view of an embodiment of a connection member according to the invention, and

FIG. 4 shows a view of a longitudinal cross-section of the connection member of FIG. 3.

### DETAILED DESCRIPTION OF THE INVENTION

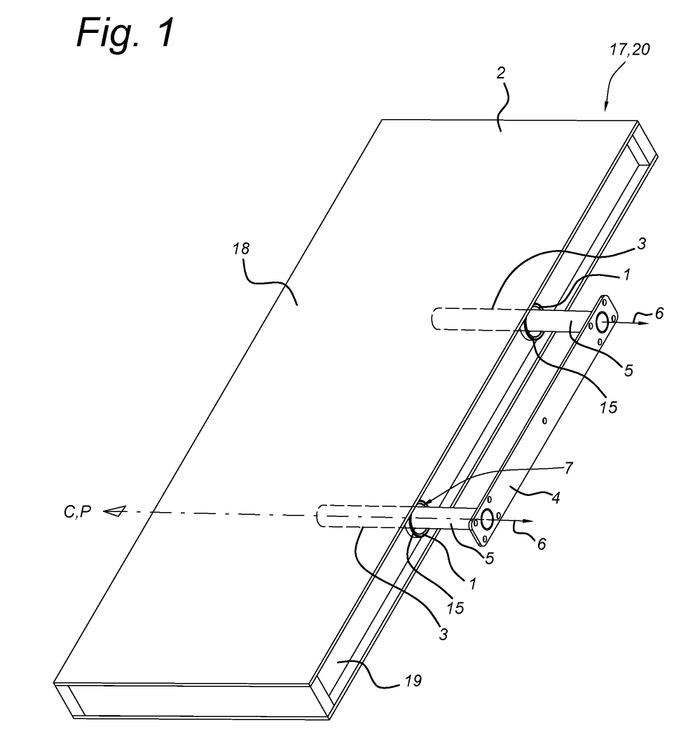

FIG. 1 shows a subassembly 17 of a wall-attachable body in the form of a floating shelf 2 and a connection member in the form of a plug 1 according to the invention. Before attaching the subassembly 17 to a wall-mounted bracket 4 to form a final wall-mounted assembly 20, the plug 1 is received into an elongated hole 3 of the floating shelf 2. FIG. 1 shows two of such holes 3 are provided along with two plugs 1 and two projection members in the form of rods 5 for insertion into insertion openings 7 of the plugs 1 upon final assembly. Other combinations and amounts of holes/plugs/projecting rods are of course also conceivable.

The floating shelf 2 has an upper and a lower (not shown) main surface 18. The upper main surface 18 can be used for supporting objects, such as books, dishes, cutlery, et cetera, and one or more side surfaces 19. The elongated holes 3 are provided in one of the side surfaces 19, in particular the side surface 19 adjoining the wall 6. Please note that the wall 6 is not shown, but its position is schematically indicated by arrows provided with the reference numeral 6. The wall-mounted bracket 4 has a base plate that is to be connected to the wall 6, e.g. with screws, such as four screws arranged in the base plate near each projecting rod 5. The wall-mounted bracket 4 is preferably mounted to the wall 6 before arrangement of the subassembly 17 thereon. The wall 6 is usually a vertical wall with the floating shelf 2 consequently extending in a horizontal direction, but it is conceivable that the wall has a slight angle with respect to the vertical.

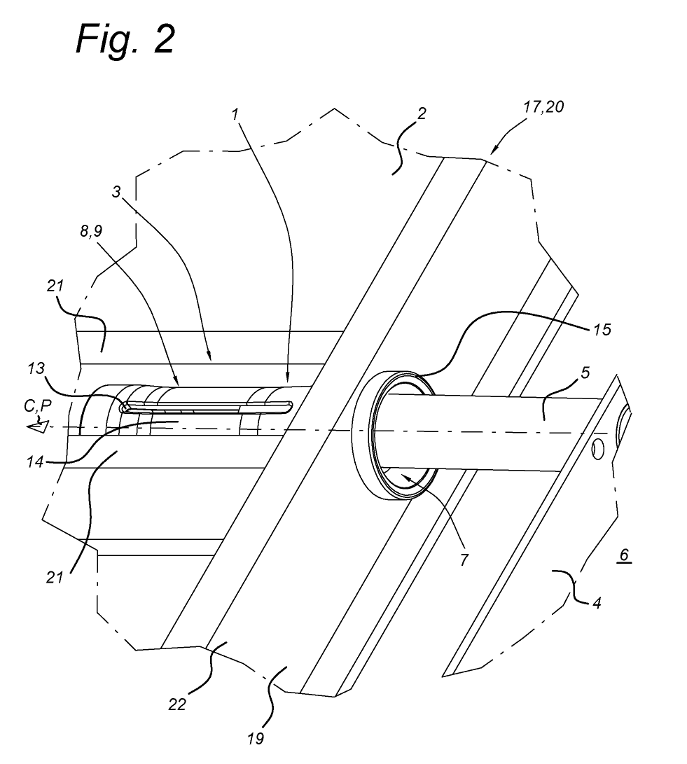

In this exemplary embodiment, the construction of the floating shelf 2 comprises two opposing main surfaces 18 and four side surfaces 19 connecting the main surfaces 18. The floating shelf 2 may have a height of for instance 3-10 cm, such as 5 cm. The width of the floating shelf 2, i.e. when looking at the wall (with the shelf 2 attached) in a direction perpendicular thereto, may for example be 50-200 cm, such as 80-150 cm, for instance 100 cm. The floating shelf 2 is preferably hollow to save weight. The elongated holes 3 may then be formed by two elongated, parallel, opposing frame members (indicated with reference numeral 21 in FIG. 2) extending inside the floating shelf 2 to delimit the hole 3. The frame members are arranged between the main support surfaces 18. The floating shelf 2 may be made of wood, such as MDF-cardboard.

The longitudinal axes of the plug 1 and the projecting rod 5 are respectively indicated by the letters C and P.

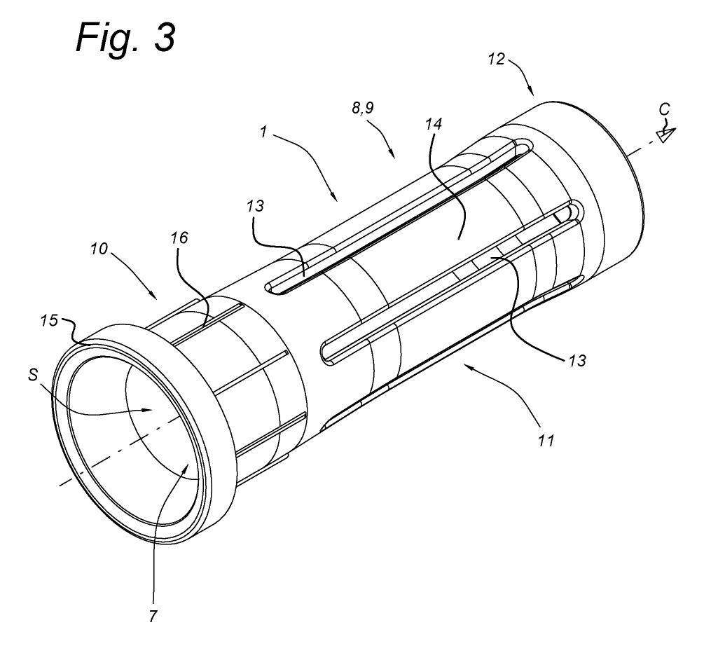

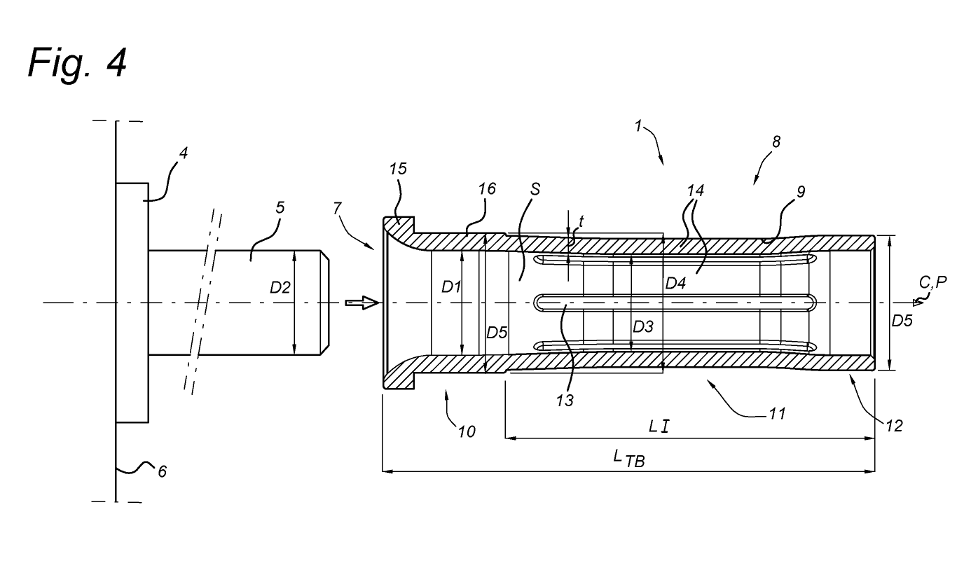

FIG. 2 shows a detailed view of the region around the insertion opening 7 of the subassembly 17 of FIG. 1. The pair of frame members 21 can be clearly seen. It can also be seen that the plug 1 is provided with a flange 15. The side surface 19 that is to adjoin the wall 6 is comprised by a frame member 22. Preferably, the plug 1 has a tubular body 8 having a tubular wall 9. The tubular wall 9 is partially provided with elongated, longitudinal slits 13 to form elongated segments 14 between the slits 13. A more detailed description of the slits 13 and the segments 14 will be provided with reference to FIGS. 3 and 4.

FIG. 3 shows a perspective view of an embodiment of the plug 1 according to the invention and FIG. 4 shows a view of a longitudinal cross-section of the plug 1 of FIG. 3.

The insertion opening 7 gives access to a hollow insertion space S delimited by the tubular plug wall 9. Both the tubular wall 9 and the insertion space S extend along the connection member axis C. The connection member axis C is alignable with the projection member axis P when the projecting member 15 is inserted into the insertion space S of the plug 1.

The tubular body 8, when viewed along the connection member axis C comprises a proximal end zone 10, provided with the insertion opening 7, an intermediate zone 11 and a distal end zone 12.

Referring now to FIG. 4, an inner diameter D1 of the tubular wall 9 in the proximal end zone 10 and the distal end zone 12 is equal to or larger than an outer diameter D2 of the projecting rod 5.

The intermediate zone is provided with slits 13 extending parallel to the connection member axis C. The slits 13 divide the tubular wall 9 in the intermediate zone 11 into multiple, elongated wall segments 14. The elongated wall segments 14 are to be made of a resilient material, such as plastic, for instance ABS. The other plug parts can also be made of the same material. However, the use of wood for producing the plug 1 is of course also conceivable. If plastic is used, the plug 1 can be conveniently produced with the help of 3D-printing technology.

The radial wall thickness t of the elongated segments 14 is so chosen that, when the projecting rod 5 is not inserted into the plug 1, an inner diameter D3 of the tubular wall 9 in the intermediate zone 11 is smaller than the outer diameter D2 of the projecting rod 15. However, when the projecting rod 5 is inserted into the insertion space S, the elongated segments 14 must be allowed to be pushed outwardly in radial direction by the projecting rod 5. Therein, an outer diameter D4 of the segments 14 is equal to an outer diameter D5 of the tubular wall 9 in the proximal end zone 10 and the distal end zone 12, such that the tubular wall 9 has a constant-diameter outer contact surface when viewed along the connection member axis C. This relatively continuous and smooth outer contact surface engages the (construction/materials delimiting the) hole 3 when the projecting rod 15 is inserted. The absence of (possibly sharp) protrusions on the outer surface prevents damage to the construction/materials used to form the hole 3. This allows the plug 1 to be inserted, removed and re-inserted again without substantial damage.

The length L1 of the intermediate zone 11 is for example 1-10 cm, preferably 2-6 cm, more preferably 3-5 cm. The length LTB of the tubular body 8 is for instance 1-15 cm, preferably 3-10 cm, more preferably 5-9 cm, most preferably 8 cm. Preferably, the elongated, tubular body 8 has a cylindrical shape.

The amount of slits 13 is for example 3-8, preferably 4-6, most preferably 6. The slits 3 are preferably evenly distributed in circumferential direction. The width of the slits 13 preferably is approximately 1-3 mm, such as 2 mm.

As stated before, the proximal end zone 10 is preferably provided with a flange 15 extending perpendicularly to the connection member axis C. The flange 15 may project with respect to the proximal end zone 10 over a distance of 1-5 mm, such as 2-4 mm, for instance 3 mm. The proximal 10 and distal 12 end zones of the tubular body 8 may have an outer diameter D5 of 1-3 cm, preferably 1.4-2.6 cm, most preferably 2.2 cm.

The outer circumference of the proximal end zone 10 can be provided with a plurality of ribs 16 extending parallel to the connection member axis C, the ribs 16 being evenly distributed in circumferential direction. The ribs 16 preferably have a relatively small radial height of for instance 0.1-0.5 mm.

The insertion opening 7 is preferably chamfered or rounded to facilitate positioning of the plug 1 on the projecting rod 5. Additionally, another opening may be provided at the distal end 12 to allow the projecting rod 5 to be inserted further into the insertion space S, if desired. The outer surface of the plug 1 may be provided with a texture or the like to improve grip. Preferably, the inner surface of the plug 1 is so formed as to require a force of 20-25 N to slide the plug 1 onto the projecting rod 5.

As stated before, the final assembly 20 can be realized by the steps of:
inserting the distal end zone 12 of the plug 1 into the elongated hole 3 of the floating shelf 2 until the proximal end zone 10 is fully inserted into the elongated hole 3, to obtain the subassembly 17,
inserting the elongated projection rod 5 into the insertion space S of the plug 1 of the subassembly 17 through the insertion opening 7,
moving the subassembly 17 in the direction of the wall 6 over the projecting rod 5 until a firm fit is provided between the projecting rod 5 and the wall-mounted bracket 4 on the one hand and the subassembly 17 on the other hand, to obtain the wall-mounted assembly 20.

Thus, the invention has been described by reference to the embodiments discussed above. It will be recognized that these embodiments are susceptible to various modifications and alternative forms well known to those of skill in the art without departing from the spirit and scope of the invention. Accordingly, although specific embodiments have been described, these are examples only and are not limiting upon the scope of the invention. It is conceivable, for instance, that the connection member is used for other connection purposes, such as for connecting a first object, such as a piece of furniture, to a second object, wherein the first object is provided with the elongated hole for receiving the connection member and the second object is provided with the projecting member (either or not via an intermediate bracket comprising the projecting member).

### REFERENCE NUMERALS

1. Plug
2. Floating shelf
3. Hole in floating shelf
4. Wall-mounted bracket
5. Projecting rod
6. Mounting wall
7. Insertion opening
8. Tubular body
9. Tubular wall
10. Proximal end zone
11. Intermediate zone
12. Distal end zone
13. Slit
14. Elongated wall segment
15. Flange
16. Rib
17. Subassembly of shelf and plug
18. Support surface of shelf
19. Side surface of shelf
20. Wall-mounted assembly
21. Hole side member
22. Shelf frame member
P=projecting rod axis
S=insertion space
C=plug axis
D1=inner diameter of tubular wall
D2=outer diameter of projecting rod
D3=inner diameter of tubular wall in intermediate zone
D4=outer diameter of the segments in the in the intermediate zone with plug inserted
D5=outer diameter of tubular wall in proximal and distal end zone
L1=length of intermediate zone
LTB=length of tubular body
t=radial wall thickness of wall segments

1. Connection member (1) for connecting a
wall-attachable body (2), having an elongated hole (3) for receiving the connection member, to a
wall-mountable bracket (4) provided with an elongated projection member (5) during use projecting away from a mounting wall (6) along a projection member axis (P), the projection member therein being insertable into an insertion space (S) of the connection member through an insertion opening (7),
the connection member comprising:
an elongated, tubular body (8) having a tubular wall (9) comprising the insertion space,
the tubular wall and the insertion space extending along a connection member axis (C) alignable with the projection member axis when the projection member is inserted into the connection member,
wherein the tubular body, when viewed along the connection member axis in a direction away from the mounting wall, comprises a proximal end zone (10), provided with the insertion opening, an intermediate zone (11) and a distal end zone (12), wherein an inner diameter (D1) of the tubular wall in the proximal end zone and the distal end zone is equal to or larger than an outer diameter (D2) of the projection member,
wherein the intermediate zone is provided with slits (13) extending parallel to the connection member axis, the slits dividing the tubular wall in the intermediate zone into multiple, elongated wall segments, the elongated wall segments (14) being made of a resilient material,
wherein a radial wall thickness (t) of the elongated segments is so chosen that,
when the projection member is not inserted into the connection member, an inner diameter (D3) of the tubular wall in the intermediate zone is smaller than the outer diameter (D2) of the projection member, whereas,
when the projection member is inserted into the insertion space, the elongated segments are pushed outwardly in radial direction by the projection member, wherein an outer diameter (D4) of the segments is equal to an outer diameter (D5) of the tubular wall in the proximal end zone and the distal end zone, wherein the tubular wall has a constant-diameter outer contact surface, when viewed along the connection member axis (C), wherein the outer surface engages the wall-attachable body in a clamping manner.

2. Connection member (1) according to claim 1, wherein the length (L1) of the intermediate zone (11) is 1-10 cm, preferably 2-6 cm, more preferably 3-5 cm.

3. Connection member (1) according to claim 1 or 2, wherein the length (LTB) of the tubular body is 1-15 cm, preferably 3-10 cm, more preferably 5-9 cm, most preferably 8 cm.

4. Connection member (1) according to any one of the preceding claims, wherein the elongated, tubular body has a cylindrical shape.

5. Connection member (1) according to any one of the preceding claims, wherein the amount of slits (13) is 3-8, preferably 4-6, most preferably 6, wherein the slits are evenly distributed in circumferential direction.

6. Connection member (1) according to any one of the preceding claims, wherein the proximal end zone (10) is provided with a flange (15) extending perpendicularly to the connection member axis.

7. Connection member (1) according to claim 6, wherein the flange projects with respect to the proximal end zone over a distance of 1-5 mm, such as 2-4 mm, for instance 3 mm.

8. Connection member (1) according to any one of the preceding claims, wherein the proximal and distal end zones of the tubular body have an outer diameter (D5) of 1-3 cm, preferably 1.4-2.6 cm, most preferably 2.2 cm.

9. Connection member (1) according to any one of the preceding claims, wherein the outer circumference of the proximal end zone is provided with a plurality of ribs (16) extending parallel to the connection member axis, the ribs being evenly distributed in circumferential direction.

10. Connection member (1) according to any one of the preceding claims, wherein the width of the slits is approximately 1-3 mm, such as 2 mm.

11. Subassembly (17) of a wall-attachable body (2) and a connection member (1) according to any one of the preceding claims, the connection member being received into the elongated hole (3) of the wall-attachable body.

12. Subassembly (17) according to claim 11, wherein the wall-attachable body (2) is a floating shelf (2) having a main support surface (18) for supporting objects and one or more side surfaces (19), wherein the elongated hole (3) is provided in one of the side surfaces, the connection member being received in the elongated hole.

13. Subassembly (17) according claim 12, wherein the side surface is provided with a plurality of elongated holes (3), such as 2, evenly spaced-apart over the side surface, for receiving a plurality of connection members (1) therein.

14. Wall-mounted assembly (20) of a wall-mounted bracket (4) provided with an elongated projection member (5) projecting away from a mounting wall along a projection member axis (P), and a subassembly (17) according to any one of the claims 11-13, the projection member (5) being inserted into the insertion space (S) of the connection member (1), wherein the outer surface of the connection member engages the wall-attachable body in a clamping manner.

15. Wall-mounted assembly (20) according to claim 14, wherein the wall-attachable body (2) is provided with a plurality of elongated holes, such as 2, receiving a plurality of connection members therein, and a plurality of elongated projection members being inserted into the plurality of connection members.

16. Method for mounting a wall-attachable body (2) to a wall-mounted bracket (4) on a mounting wall (6), the wall-attachable body comprising an elongated hole (3) for receiving a connection member (1) according to any one of the claims 1-10, the wall-mounted bracket being provided with an elongated projection member (5) projecting away from the mounting wall along a projection member axis (P), the projection member therein being insertable into the insertion space (S) of the connection member through the insertion opening (7), comprising the steps of:
inserting the distal end zone (12) of the connection member into the elongated hole of the wall-attachable body until the proximal end zone (10) is fully inserted into the elongated hole, to obtain a subassembly (17) according to any one of the claims 11-13,
inserting the elongated projection member (5) into the insertion space (S) of the connection member (1) of the subassembly (17) through the insertion opening (7),
moving the subassembly (17) in the direction of the wall (6) over the projection member until a firm fit is provided between the projection member and the wall-mounted bracket on the one hand and the subassembly (17) on the other hand, to obtain the wall-mounted assembly (20) according to claim 14 or 15, wherein the outer surface of the connection member engages the wall-attachable body in a clamping manner.
